(19) United States
(12) Patent Application Publication
(10) Pub. No.: US 2008/0184581 A1
(43) Pub. Date: Aug. 7, 2008

(54) Tape ruler

(75) Inventor: Jason Huang, Taipei (TW)

Correspondence Address: BRUCE H. TROXELL, SUITE 1404, 5205 LEESBURG PIKE, FALLS CHURCH, VA, 22041, US

(73) Assignee: INDEX MEASURING TAPE CO., LTD.

(21) Appl. No.: 11/701,559

(22) Filed: Feb. 2, 2007

(51) Int. Cl. G01B 3/10

(52) U.S. Cl. 33/769

(57) ABSTRACT

Disclosed is an improved tape ruler, comprising mainly a hollow housing constructed by two parts (the left and the right) to form a space for other components to place in, a roller of ruler blade placed in said space, two interiorly protruding axis tubes respectively set on the middle of the left and the right parts of the housing, two supplementary tubes of different materials set on the interiors of said axis tubes, two protruding tubes that match said axis tubes, two sleeves of different materials further mounted onto said protruding tubes. Said protruding tubes are respectively coupled up with said two axis tubes, allowing the roller to rotate in said space. One rolling spring is placed inside said roller, with one end of it reaching out from an arsis post that extends from the housing inside one of said protruding tubes, and the other end connected with the end of said ruler blade. There is also one other strip-shaped exit formed the tip of the tape. By reducing rotational friction between said axis tubes and the protruding tubes which are set on the interiors of the right and the left half-housings, the resistance force of said tape ruler is greatly alleviated, the length of said spring that pulls the ruler blade out is greatly shortened, and it is therefore more suitable for the use of tape ruler with wider ruler blades.

### BACKGROUND OF THE INVENTION

1. Field of the Invention

The present invention relates to an improved tape ruler, especially to an advanced tape ruler that has sleeves mounted onto protruding tubes formed on the interior walls of its right and left parts of housing, as well as supplementary tubes set on the axis tubes of its roller. Then the rotational frictions between said protruding tubes and axis tubes can be greatly reduced, the length of spring that pulls the tape out then can be shortened, and makes it more suitable for wider ruler blades.

2. Description of the Prior Art

Traditional tape rulers comprise of a housing in which there is a space inside to place ruler blade and a roller. One roller is placed within said space, whereas one axis is set on the interior wall of the housing. Said roller is set on the axis and is able to roll within the space. One rolling spring is set in said roller; one end of said spring is connected with the axis, whereas the other end of it is connected with the interior wall of said roller. Said roller is wrapped up with the ruler blade; one protruding strip-shaped exit is designed as at the lower end of the housing, so that when the roller blade is pulled out, the force of the rolling spring will be able to bring it back to the inside of the housing. In addition, a button is set on the upper corner of the housing, with one arc-shaped depressing strip set within the button. As the user presses the button with his/her thumb, said depressing strip will move along the arch-shaped groove formed on the shell and further makes the arch-shaped depressing strip within to move downward, so as to stop the ruler blade under the depressing strip. This allows the ruler blade to stop at a proper point without getting rolled back when it's being pulled out.

When using the tape ruler, the ruler blade can be pulled out to a certain length and stopped at a certain point to measure the length of objects. Nevertheless, when it comes to said traditional tape ruler, its roller is wholly coupled onto said axis formed on the interior wall of the housing or the bearings of the axis. Said roller and axis, or said roller and the bearings of the axis, will generate excessive friction because the contact area is too large or because the materials of the roller, the axis formed on the interior wall of the housing and the axis bearing are different. Rough rolling of the ruler is more likely to happen because of the above contributors, and such roughness will result in large amount of rolling resistance force. Thus, longer springs have to be adopted to pull the ruler blade back. Therefore, when using wider ruler blades, longer springs, axis, bearing of the axis are needed, which make the entire tape ruler much heavier and more inconvenient.

Accordingly, the present invention has been invented to solve the above-mentioned problems occurred in the conventional tape ruler.

### SUMMARY OF THE INVENTION

In view of the drawbacks of the above mentioned prior art, based on his experiences and skills and with continuous efforts, the inventor strives to come up with solutions to improve the prior art and finally succeeds in producing the present invention, hoping to dismiss said drawbacks.

An object of the present invention is to provide an improved tape ruler that greatly alleviates the resistance force of its roller and therefore shortens the spring that pulls out/draws back its ruler blade. It is also more suitable for the use of wider ruler blades.

According to the above mentioned object, the present invention provides an advanced tape ruler, comprising mainly a hollow housing constructed by two parts (the left and the right) to form a space for other components to place in, a roller of ruler blade placed in said space, two interiorly protruding axis tubes respectively set on the middle of the left and the right parts of the housing, two supplementary tubes of different materials set on the interiors of said axis tubes, two protruding tubes that match said axis tubes, two sleeves of different materials further mounted onto said protruding tubes. Said protruding tubes are respectively coupled up with said two axis tubes, allowing the roller to rotate in said space. One rolling spring is placed inside said roller, with one end of it reaching out from an arsis post that extends from the housing inside one of said protruding tubes, and the other end connected with the end of said ruler blade. There is also one other strip-shaped exit formed the tip of the tape. By reducing rotational friction between said axis tubes and the protruding tubes which are set on the interiors of the right and the left half-housings, the resistance force of said tape ruler is greatly alleviated, the length of said spring that pulls the ruler blade out is greatly shortened, and it is therefore more suitable for the use of tape ruler with wider ruler blades. When using wider ruler blades, the weight of the present invention will not greatly increase, and the rotation of its roller can be very effort-saving.

The above purposes and structure of the present invention will be more apparent from the following detailed description taken in conjunction with the accompanying drawings wherein:

### BRIEF DESCRIPTION OF THE DRAWINGS

FIG. 1 is an overall view of the present invention;

FIG. 2 is an exploded view of the present invention;

FIG. 3 is the longitudinal sectional view of the present invention;

FIG. 4 is the cross sectional view of the present invention.

### DETAILED DESCRIPTION OF THE PREFERRED EMBODIMENT

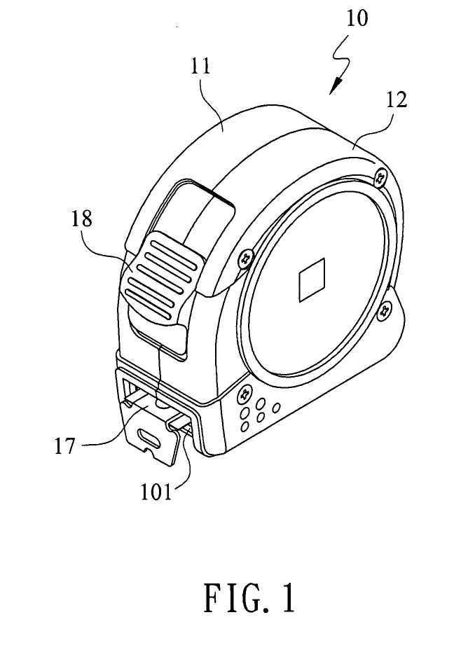

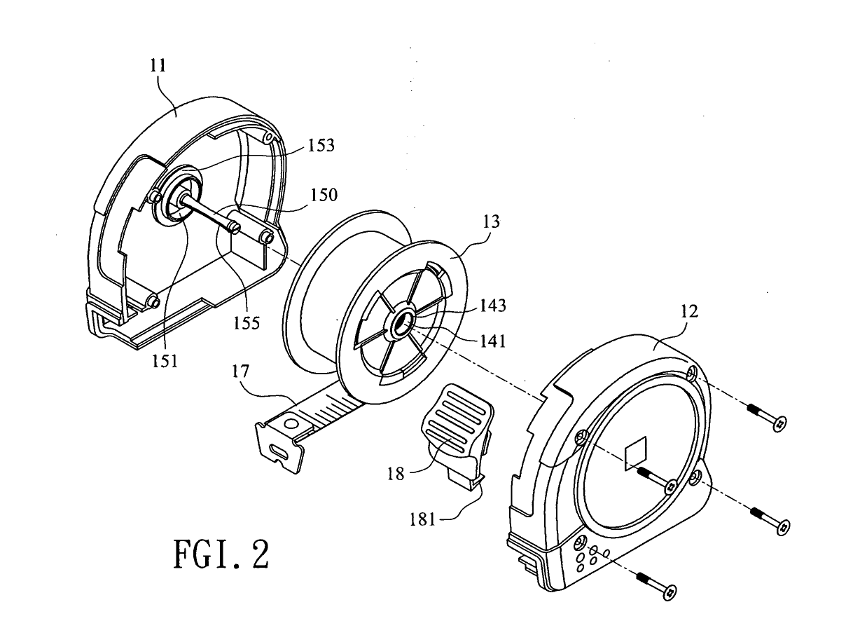

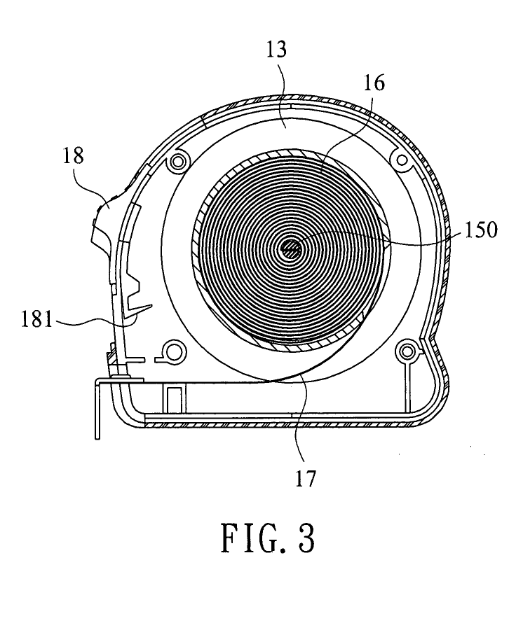

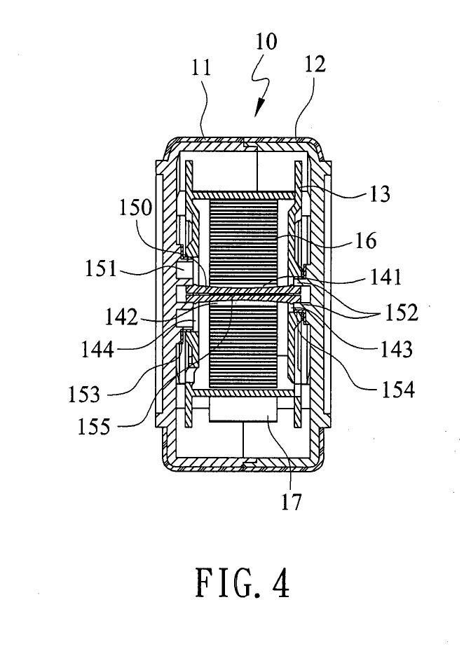

The present invention relates to an improved tape ruler, as shown in FIG. 1, FIG. 2, FIG. 3, and FIG. 4. The present invention is equipped with one plastic-injected hollow housing 10, which is formed by mounting one left housing 11 and one right housing 12 together. There is one space inside said hollow housing 10 and one roller 13 is placed in said space. Two inwardly protruding axis tubes 141 and 142 are respectively formed on the middle of the left and the right side walls of the roller 13, whereas two supplementary tubes 143 and 144, which are made of materials different from that forming the roller 13, are set on the interior walls of said axis tubes. Two protruding tubes 151 and 152, which match said axis tubes 141 and 142, are respectively formed on the interior walls of the housing 11 and 12. Sleeves 153 and 154, which are made of different materials such as copper and iron, are respectively mounted onto said protruding tubes 153 and 154 (thus said protruding tubes 151 and 152 are placed inside said axis tubes 141 and 142). Then the sleeves 153 and 154 of said protruding tubes 151 and 152 are respectively coupled with the supplementary tubes 143, 144 of said two axis tubes 141 and 142, allowing roller 13, which is placed within said space, to rotate in such a space. One interiorly-protruding axis post 150, which connects the two interior walls of housings 11 and 12 surrounded said protruding tubes 151 and 152, is set within said hollow housing 10. One creak 155 is formed on the axis post 150.

A rolling spring 16 is set within said roller 13; one end of spring 16 is connected with axis post 150 that sticks out from the bottom of the protruding tube 151, whereas the other end of spring 16 is connected with the tip of ruler blade 17—which is set on the roller 13. That is, one tip of ruler blade 17 passes through roller 13 and gets connected to spring 16 and the other tip sticks out of the hollow housing 10 from its strip-shaped exit 101. Said ruler blade 17 is wounded over the surface of roller 13, so that when the ruler blade 17 is pulled out from the shell, with the resilience of rolling spring 16, said roller 13 starts to rotate and then rolls tape 17 back to the inside of the hollow housing 10.

A push button 18 is placed on the oblique upper corner of the hollow housing 10. An arch-shaped depressing strip 181 is set inside the push button 18, allowing said push button 18 to move along the arch-shaped groove formed on said housing when the user presses the push button with his/her thumbs. Furthermore, the arch-shape controlling strip 181 will move downwards to press the ruler blade to stop. Thus, when the ruler blade 17 is pulled out, it can be stopped at a proper point and will not be rolled back.

When using the present invention, the ruler blade 17 can be pulled out to a proper length and be stopped at such a length by pressing push button 18 to measure the length of an object.

With the decrease of friction between sleeves 153 and 154, which are respectively mounted onto said protruding tubes 151 and 152 formed on the interior walls of the left and right half-housings 11 and 12, and the supplementary tubes 143 and 144, which are set interiorly onto said protruding axis tubes 141 and 142 extended inwardly from two side walls of roller 13, the resistance force of the roller 13 is then greatly alleviated, while the length of spring 16, which pulls out and draws in the ruler blade 17, can also be shortened. In this way, when using a wider ruler blade, the entire tape ruler will not become too heavy because of the weight of spring, axis of the roller, or bearings of the axis, and the rotation of the tape ruler can still be powerful.

It is noticed that lengths of the protruding axis tubes 141 and 142 extended inwardly from two side walls of the roller 13 are smaller then the length of axis tube formed in the roller of conventional tape ruler. Furthermore, the material for forming the supplementary tubes 143 and 144 attached onto the interior wall of said protruding axis tubes 141 and 142 is metal, such as copper, or iron, or steel, or any other friction endurable material, and, the sleeves 153 and 154, which are respectively mounted onto the protruding tubes 151 and 152 formed on the interior walls of the left and right half-housings 11 and 12, also made of metal, such as copper, or iron, or steel, or any other friction endurable material. Then the frictions between said protruding axis tubes 141 and 142, and said protruding tubes 151 and 152, are greatly reduced.

In the present invention, the width of the ruler blade 17 is between 1.7 inches (43.18 mm) and 2 inches (50.8 mm), whereas the length of ruler blade 17 is longer than the spring 16. In addition, the thickness of spring 16 is greater than the ruler blade 17 (approximately above 0.10 mm), so that the ruler blade 17 will easily be pulled out of or drawn back in the housing 10.

With regard to the above mentioned statements, the present invention of an improved tape ruler displays unprecedented novelty that has not yet been made public. In addition, the features and functions of the present invention contribute to its non-obviousness when compared with traditional tape rulers. Therefore, the filing of the present invention is consistent with conditions of approvable patent.

Although the above-mentioned embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An improved tape ruler, comprising mainly:
a hollow housing which is formed of one left half-housing and one right half-housing, whereas inside said housing there is a space for a roller to place in, characterized in that:
two inwardly extended axis tubes are respectively formed on the middle of the left and the right side walls of the shell,
two supplementary tubes made of friction endurable materials that are set on the interiors of said axis tubes,
two protruding tubes are respectively formed on the interior walls of the left and right half-housings, and which are respectively coupled up with said axis tubes,
two sleeves are respectively mounted onto said protruding tubes, allowing said roller to rotate inside said space,
a rolling spring is set in said roller, with its one end connected with an axis post that sticks out from said hollow housing and the other end connected with the tip of a ruler blade wounded on said roller;
With the mere existence of the rotational friction between said sleeves mounded onto the protruding tubes formed on the interiors walls of the left and the right half-housings and the complimemtary tubes respectively attached on the interior wall of protruding said axis tubes, the resistance force of the roller in rotation is greatly alleviated and therefore the length of said spring that pulls out and draws in the ruler blade is also shortened, and can be more suitable for the use of wider ruler blade.

2. The tape ruler as claimed in claim 1, wherein the width of the wider ruler blade is between 1.7 inches (43.18 mm) and 2 inches (50.8 mm).

3. The tape ruler as claimed in claim 1, wherein the length of said ruler blade is longer than the spring.

4. The tape ruler apparatus as claimed in claim 1, wherein the thickness of spring is greater than that of the ruler blade (at least 0.10 mm).

5. The tape ruler as claimed in claim 1, wherein the sleeves that are mounted onto the protruding tubes formed on the interior walls of the left and right self-housings is made of copper or iron or steel or any other friction endurable materials.

6. The tape ruler as claimed in claim 1, wherein the supplementary tubes that are attached onto the inside of the inwardly protruded axis tubes that are formed on the middle of the two side walls of said roller is made of copper or iron or steel or any other friction endurable materials.

7. The tape ruler as claimed in claim 1, wherein the two ends of said interiorly protruded axis post extend to the spaces surrounded by said two protruding tubes formed on the interior side walls of said half housings.

8. The tape ruler as claimed in claim 7, wherein a creak is formed said axis post for one end of said spring to connect with.
